(19) United States
(12) Patent Application Publication
(10) Pub. No.: US 2026/0011922 A1
(43) Pub. Date: Jan. 8, 2026

(54) ANTENNA ELEMENT, ANTENNA SUBSTRATE, AND ANTENNA MODULE

(71) Applicant: KYOCERA Corporation, Kyoto-shi, Kyoto (JP)

(72) Inventors: Soichiro AOISHI, Kirishima-shi, Kagoshima (JP); Hikaru KITAHARA, Kirishima-shi, Kagoshima (JP)

(73) Assignee: KYOCERA Corporation, Kyoto-shi, Kyoto (JP)

(21) Appl. No.: 18/879,982

(22) PCT Filed: Jun. 28, 2023
(86) PCT No.: PCT/JP2023/023994

§ 371 Date: Dec. 30, 2024

(30) Foreign Application Priority Data
Jun. 30, 2022 (JP) 2022-105808

(51) Int. Cl. H01Q 9/04; H01Q 5/385; H01Q 21/06

(52) U.S. Cl. CPC H01Q 9/0414; H01Q 5/385; H01Q 21/065

(57) ABSTRACT

An antenna element includes a ground conductor, an energization patch conductor positioned on an upper side relative to the ground conductor, and a non-energization patch conductor positioned on an upper side relative to the energization patch conductor. The energization patch conductor includes a first side and a second side extending along a resonance direction. The non-energization patch conductor includes a plurality of segments. The plurality of segments include a first segment positioned along the first side and a second segment positioned along the second side. In plan view, a total area of the non-energization patch conductor is smaller than an area of the energization patch conductor.

### TECHNICAL FIELD

The present disclosure is related to an antenna element, an antenna substrate, and an antenna module.

### BACKGROUND OF INVENTION

Japanese Unexamined Patent Application Publication No. 2015-92658 describes an antenna element. This antenna element includes an energization patch conductor to which an energization conductor is connected, a plurality of non-energization patch conductors positioned on the upper side relative to the energization patch conductor, and a plurality of auxiliary patch conductors positioned so as not to superposed on the energization patch conductor.

### SUMMARY

### Solution to Problem

In the present disclosure, an antenna element includes
a ground conductor, an energization patch conductor positioned on an upper side relative to the ground conductor, and a non-energization patch conductor positioned on an upper side relative to the energization patch conductor.

The energization patch conductor includes a first side and a second side extending along a resonance direction.

The non-energization patch conductor includes a plurality of segments.

The plurality of segments include a first segment positioned along the first side and a second segment positioned along the second side.

In plan view, a total area of the non-energization patch conductor is smaller than an area of the energization patch conductor.

In the present disclosure, an antenna substrate includes
a plurality of antenna elements.

Each of the plurality of antenna elements is the above-described antenna element.

In the present disclosure, an antenna module includes
the above-described antenna substrate and
an integrated circuit.

### BRIEF DESCRIPTION OF THE DRAWINGS

FIG. 1A is a perspective view illustrating an antenna element of Embodiment 1 according to the present disclosure.

FIG. 1B is a plan view illustrating the antenna element of Embodiment 1 according to the present disclosure.

FIG. 2 is a sectional view taken along line A-A illustrated in FIG. 1B.

FIG. 3A is a reflection characteristic graph illustrating frequency characteristics of the antenna element of Embodiment 1 and an antenna element of Comparative Example 1.

FIG. 3B is a gain graph illustrating the frequency characteristics of the antenna element of Embodiment 1 and the antenna element of Comparative Example 1.

FIG. 4A is a graph illustrating the relationship between a distance d1 and a total width wₜₒₜ of segments of a non-energization patch conductor.

FIG. 4B is a Smith chart illustrating the relationship between the distance d1 and the total width wₜₒₜ of the segments of the non-energization patch conductor.

FIG. 5A is a first example of a longitudinal sectional view that explains a minimum distance between an energization patch conductor and the non-energization patch conductor.

FIG. 5B is a second example of a longitudinal sectional view that explains the minimum distance between the energization patch conductor and the non-energization patch conductor.

FIG. 6 is a graph illustrating the relationship between the distance d1 of the segments and a fractional bandwidth.

FIG. 7A illustrates a current density distribution of a non-energization patch conductor of Embodiment 2.

FIG. 7B illustrates the current density distribution of a non-energization patch conductor of Embodiment 3.

FIG. 7C illustrates the current density distribution of a non-energization patch conductor of Comparative Example 1 2.

FIG. 7D illustrates the current density distribution of a non-energization patch conductor of Comparative Example 3.

FIG. 8A is a graph illustrating the reflection characteristics of Embodiment 2.

FIG. 8B is a graph illustrating the reflection characteristics of Embodiment 3.

FIG. 8C is a graph illustrating the reflection characteristics of Comparative Example 2.

FIG. 8D is a graph illustrating the reflection characteristics of Comparative Example 3.

FIG. 9 is a graph illustrating the relationship between the distance d1 of the segments and in-band reflection.

FIG. 10A is a frequency characteristic graph illustrating the relationship between the distance d1 of the segments and a gain.

FIG. 10B is a graph of an in-band minimum gain illustrating the relationship between the distance d1 of the segments and the gain.

FIG. 11 is a graph illustrating the relationship between a minimum distance d2min and the in-band minimum gain.

FIG. 12A is a sectional view illustrating an antenna element of Embodiment 4.

FIG. 12B is a graph illustrating the relationship between a distance d1b illustrated in FIG. 12A and the in-band minimum gain.

FIG. 13A is a plan view illustrating an antenna element of Embodiment 5.

FIG. 13B is a plan view illustrating an antenna element of Embodiment 6.

FIG. 14A is a reflection characteristic graph illustrating the frequency characteristics of the antenna elements of Embodiments 1, 5, and 6.

FIG. 14B is a gain graph illustrating the frequency characteristics of the antenna elements of Embodiments 1, 5, and 6.

FIG. 15A is a sectional view illustrating the antenna element of Embodiment 7 in which the total number of the segments of the non-energization patch conductor is greater than or equal to three.

FIG. 15B is a sectional view illustrating the antenna element of Embodiment 8 in which the total number of the segments of the non-energization patch conductor is greater than or equal to three.

FIG. 15C is a sectional view illustrating the antenna element of Embodiment 9 in which the total number of the segments of the non-energization patch conductor is greater than or equal to three.

FIG. 15D is a sectional view illustrating the antenna element of Embodiment 10 in which the total number of the segments of the non-energization patch conductor is greater than or equal to three.

FIG. 16A is a reflection characteristic graph illustrating the frequency characteristics of the antenna elements of Embodiments 1 and 7 to 10.

FIG. 16B is a gain graph illustrating the frequency characteristics of the antenna elements of Embodiments 1 and 7 to 10.

FIG. 17A is a plan view illustrating an antenna substrate and an antenna module of an embodiment according to the present disclosure.

FIG. 17B is a sectional view taken along line B-B illustrated in FIG. 17A.

### DESCRIPTION OF EMBODIMENTS

Hereinafter, embodiments according to the present disclosure will be described in detail with reference to the drawings.

### Embodiment 1

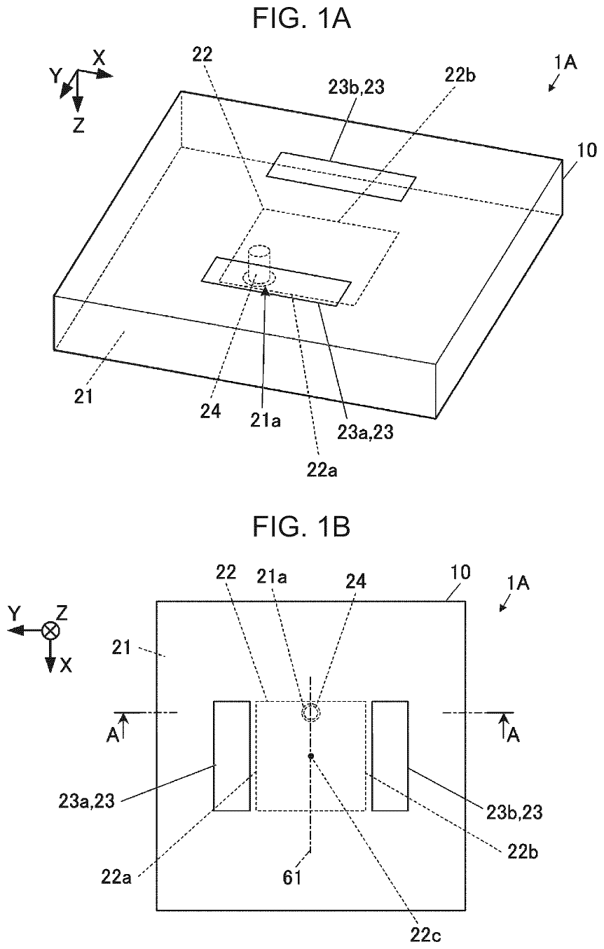

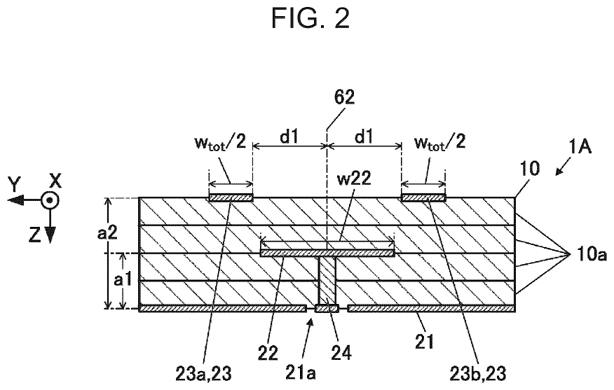

FIGS. 1A and 1B are respectively a perspective view and a plan view illustrating an antenna element of Embodiment 1 according to the present disclosure. FIG. 2 is a sectional view taken along line A-A illustrated in FIG. 1B. In the description below, a Z direction in the drawings extends vertically downward, and an X direction and a Y direction perpendicular to the Z direction are defined as horizontal directions. The Z direction is perpendicular to a surface of a ground conductor 21 on an energization patch conductor 22 side (an upper surface). The X direction and the Y direction extend along the upper surface of the ground conductor 21 and are perpendicular to each other. Herein, upper/lower and left/right directions may be different from upper/lower and left/right directions of an antenna element 1A in use.

### <Basic Configuration>

In Embodiment 1, the antenna element 1A includes the ground conductor 21, the energization patch conductor 22 positioned on the upper side relative to the ground conductor 21, and a non-energization patch conductor 23 positioned on the upper side relative to the energization patch conductor 22. The “patch conductor” may mean a plate conductor or a film conductor.

The upper surface of the ground conductor 21 may expand in a planar shape. The energization patch conductor 22 and the non-energization patch conductor 23 may have a planar shape. The energization patch conductor 22 and the non-energization patch conductor 23 may be positioned such that one of plate surfaces of the energization patch conductor 22 and one of plate surfaces of the non-energization patch conductor 23 face the upper surface of the ground conductor 21. More specifically, the upper surface of the ground conductor 21, the plate surfaces of the energization patch conductor 22, and the plate surfaces of the non-energization patch conductor 23 may be parallel to each other. The plate surfaces mean, out of outer surfaces, two surface larger than other surfaces. The one plate surface of the energization patch conductor 22 and the one plate surface of the non-energization patch conductor 23 that face the upper surface of the ground conductor 21 are lower surfaces.

The antenna element 1A may include a dielectric substrate 10. The ground conductor 21, the energization patch conductor 22, and the non-energization patch conductor 23 may be positioned in the dielectric substrate 10. The dielectric substrate 10 may include a multilayer structure and a plurality of dielectric substrates 10a (FIG. 2). The energization patch conductor 22 may be positioned inside the dielectric substrate 10. The non-energization patch conductor 23 may be positioned on an upper surface of the dielectric substrate 10. The ground conductor 21 may be positioned on a lower surface of the dielectric substrate 10 or inside the dielectric substrate 10.

The antenna element 1A may include an energization conductor 24 configured to transmit a sending signal or a receiving signal. The energization conductor 24 may extend in the upper-lower direction through a through hole 21a of the ground conductor 21 and may be connected to the energization patch conductor 22.

With the antenna element 1A configured as above, when energization corresponding to the sending signal of a target frequency band is performed on the energization patch conductor 22 through the energization conductor 24, electrical resonance in a resonance direction occurs in the energization patch conductor 22 and the non-energization patch conductor 23. Thus, a radio wave is radiated from the energization patch conductor 22 and the non-energization patch conductor 23. When the antenna element 1A receives a radio wave of the target frequency band from the outside, electrical resonance in the resonance direction occurs in the energization patch conductor 22 and the non-energization patch conductor 23. Thus, a receiving signal is sent from the energization patch conductor 22 to the energization conductor 24. The target frequency band means a frequency band of radio waves to be sent or received.

### <Energization Patch Conductor and Non-energization Patch Conductor>

The energization patch conductor 22 may have a quadrangular shape, a rectangular shape, or a square shape in plan view (FIG. 1B). The plan view means a view seen through from the upper side.

The energization patch conductor 22 may include a first side 22a and a second side 22b extending along the resonance direction. The resonance direction corresponds to a direction parallel to a straight line 61 connecting a center 22c of the energization patch conductor 22 and a center of an energization point (a connecting point of the energization conductor 24).

The non-energization patch conductor 23 may be divided into a plurality of segments, and the non-energization patch conductor 23 may include the plurality of segments. The plurality of segments may include a first segment 23a extending along the first side 22a of the energization patch conductor 22 and a second segment 23b extending along the second side 22b of the energization patch conductor 22. When “a segment extends along a certain line segment”, the relationship between this segment and the line segment is as follows: the segment in question is positioned relatively close to the above-described line segment compared to another line segment; and a longitudinal direction of the segment in question is parallel to or substantially parallel to the above-described line segment. The term “substantially parallel” may mean within ±10° from an exact parallel relationship.

In Embodiment 1, as illustrated in FIG. 1A, the total number of the segments of the non-energization patch conductor 23 may be two. The first segment 23a and the second segment 23b may have the same size and the same shape and may be, in plan view, point symmetric with respect to the center 22c of the energization patch conductor 22.

In plan view, the total area of the non-energization patch conductor 23, that is, the total area of the plurality of segments (23a and 23b) may be smaller than the area of the energization patch conductor 22. When the non-energization patch conductor 23 includes the plurality of segments and the above-described difference in area exists, widening of the band of the antenna element 1A can be achieved and the gain of the antenna element 1A can be improved. The details of these effects will be provided in the description of <Characteristics of Antenna Element> and <Distance and Width of Segment>.

### <Parameters of Simulation>

Hereinafter, some results of simulation may be described. Parameters applied to the simulation are indicated with reference to FIG. 2. In the simulation, the parameters are as follows: a width w22 of the energization patch conductor 22 is 0.75 mm; the shape of the energization patch conductor 22 in plan view is a square; a distance a1 between the centers in the respective thicknesses of the ground conductor 21 and the energization patch conductor 22 is 0.2 mm; a distance a2 between the centers in the respective thicknesses of the ground conductor 21 and the non-energization patch conductor 23 is 0.4 mm; the relative dielectric constant of the dielectric substrate 10 is 5.7; and the target frequency band is 64 GHz band (specifically, 57 to 71 GHz). Furthermore, unless otherwise specified, the length of the non-energization patch conductor 23 and the length of the energization patch conductor 22 are coincident in the resonance direction, and the position of the energization patch conductor 22 and the position of the non-energization patch conductor 23 do not deviated from each other in the resonance direction.

### <Characteristics of Antenna Element>

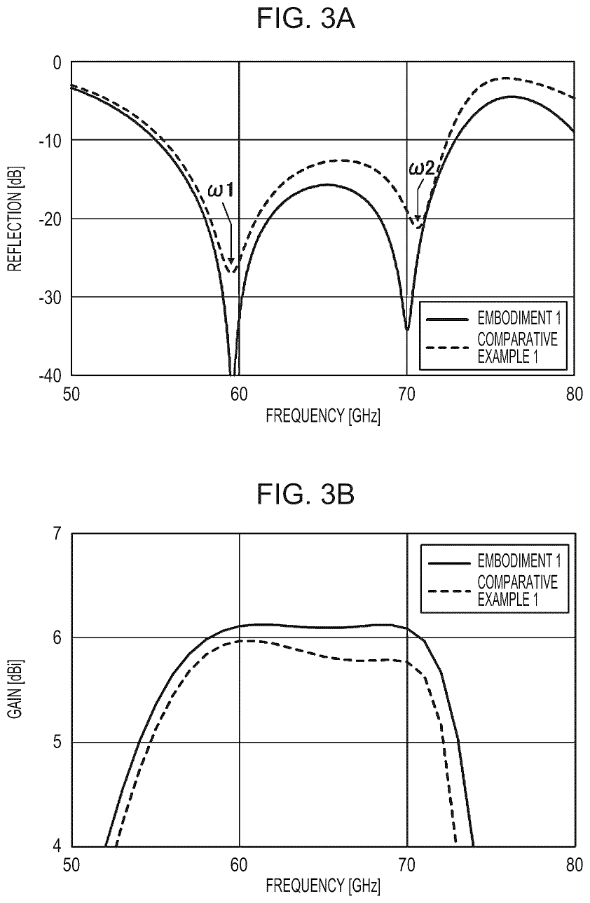

FIGS. 3A and 3B are a reflection characteristic graph and a gain graph, respectively. Each of these graphs illustrates the frequency characteristics of the antenna elements of Embodiment 1 and Comparative Example 1. The graphs are results from the simulation of the antenna element 1A of Embodiment 1 and the antenna element of Comparative Example 1. This is also applicable to reflection characteristic graphs and gain graphs to be described below in the same and/or similar manner.

Referring to FIGS. 3A and 3B, the antenna element of Comparative Example 1 is configured identically to the antenna element 1A of Embodiment 1 except for that the non-energization patch conductor is configured differently from that of Embodiment 1. The non-energization patch conductor of Comparative Example 1 is configured as a single unit having a rectangular shape (for example, a substantially square shape) and positioned such that the centers of the non-energization patch conductor and the energization patch conductor are superposed on each other in plan view. The non-energization patch conductor 23 of Embodiment 1 and the non-energization patch conductor of Comparative Example 1 are adjusted in size such that impedance matching is obtained in the target frequency band.

As illustrated in FIGS. 3A and 3B, compared to that of Comparative Example 1, the antenna element 1A of Embodiment 1 reduces reflection in the target frequency band and improves the gain. The antenna element 1A of Embodiment 1 exhibits a wider frequency band in which the reflection is smaller than or equal to −10 dB and a wider frequency band in which a gain of greater than or equal to 5 dB is obtained than those of Comparative Example 1. Accordingly, compared to that of Comparative Example 1, the antenna element 1A of Embodiment 1 achieves widening of the band.

### <Distance and Width of Segments>

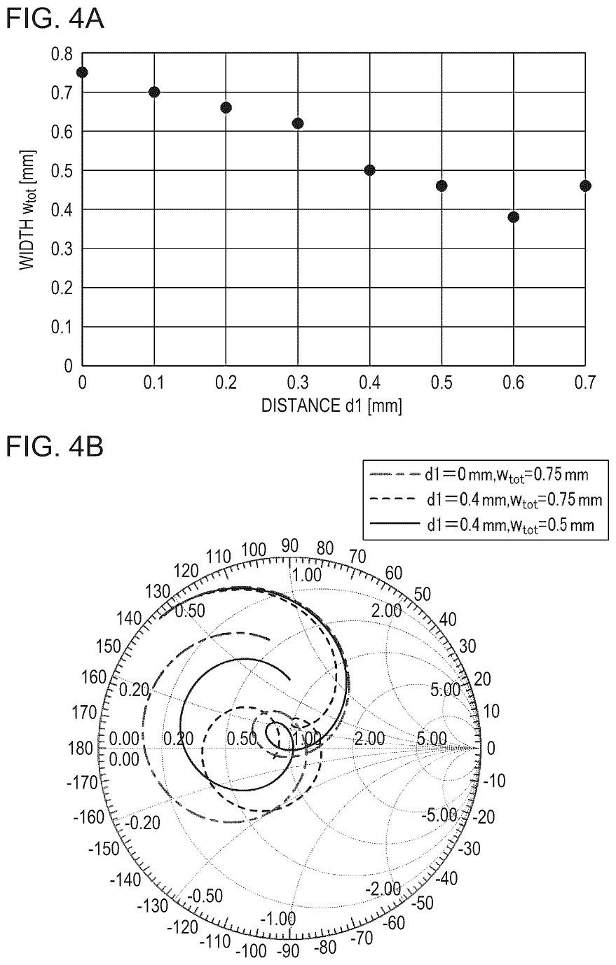

FIG. 4A is a graph illustrating the relationship between a distance d1 and a total width wₜₒₜ of the segments of the non-energization patch conductor. FIG. 4B is a Smith chart illustrating the relationship. The relationship illustrated in FIG. 4A and the impedance characteristics illustrated in FIG. 4B are obtained from the simulation results.

As illustrated in FIG. 2, the first segment 23a and the second segment 23b may have the total width wₜₒₜ and may be separated from a central plane 62 by the distance d1. The central plane 62 means a virtual vertical plane extending along the resonance direction and passing through the center of the energization patch conductor 22. The total width wₜₒₜ and the distance d1 are lengths in the horizontal direction perpendicular to the resonance direction. The width of the first segment 23a is wₜₒₜ/2, and the width of the second segment 23b is wₜₒₜ/2. The distance between the first segment 23a and the second segment 23b is 2×d1.

The impedance of the antenna element 1A changes depending on the width wₜₒₜ and the distance d1. As an impedance locus illustrated in FIG. 4B indicates, with a configuration in which d1 is 0 mm and wₜₒₜ is 0.75 mm, the impedance locus approaches the center of the chart (that is, 50 Ω) in the proximity of the center of the target frequency band, and the impedance matching is obtained. In contrast, with a configuration in which wₜₒₜ is maintained at 0.75 mm and d1 is 0.4 mm, the impedance locus is separated upward from the center of the chart in the proximity of the center of the target frequency band, and the impedance matching is not obtained. The proximity of the center of the target frequency band corresponds to a closed loop portion of the impedance locus.

To obtain the impedance matching with the distance d1 fixed, a total width wₜₒₜ corresponding to the distance d1 may be selected. In general, a stacked patch antenna including an energization patch conductor and a non-energization patch conductor has two poles ω1 and ω2 of the resonance frequency (see FIG. 3A). Widening of the band is achieved by causing the frequencies of two poles ω1 and ω2 to be different from each other. The resonance of the energization patch conductor contributes mainly to the lower pole ω1, and the resonance of the non-energization patch conductor contributes mainly to the higher pole ω2.

Accordingly, when the impedance locus is positioned above the center of the chart in the proximity of the center of the target frequency band, the total width wₜₒₜ of the segments (23a and 23b) of the non-energization patch conductor 23 may be reduced so as to reduce a capacitance component of the non-energization patch conductor 23. With this configuration, the impedance locus can be caused to approach the center of the chart in the proximity of the center of the target frequency band. As illustrated in FIG. 4B, when d1 is 0.4 mm, setting wₜₒₜ to 0.5 mm causes the closed loop portion of the impedance locus to approach the center of the chart so as to surround the center of the chart, and the impedance matching is obtained.

The graph of FIG. 4A illustrates the relationship between the distance d1 and the total width wₜₒₜ when the impedance matching is obtained as described above. As illustrated in the graph, when the impedance matching is obtained, the total width wₜₒₜ may be reduced as the distance d1 increases within a range in which the distance d1 is not excessively large.

In the graph illustrated in FIG. 4A, a dot at d1=0 mm corresponds to the configuration of Comparative Example 1 with the non-energization patch conductor 23 configured as the single unit. In this configuration, the area of the energization patch conductor 22 and the area of the non-energization patch conductor 23 are coincident with each other. Accordingly, the antenna element 1A of Embodiment 1 in which d1 is great than 0 mm corresponds to a configuration in which the width wₜₒₜ is smaller than that of Comparative Example 1, that is, the total area of the non-energization patch conductor 23 is smaller than the area of the energization patch conductor 22. With this configuration, the impedance matching is obtained, and widening of the band of the antenna element 1A and improvement of the gain of the antenna element 1A are achieved. That is, with the configuration in which the non-energization patch conductor 23 includes the plurality of segments and the toral area of the non-energization patch conductor 23 is smaller than the area of the energization patch conductor 22, widening of the band of the antenna element 1A can be achieved and the gain of the antenna element 1A can be improved as illustrated in FIGS. 3A and 3B.

<Ranges of Distance d1 of Segments and Minimum Distance d2min>

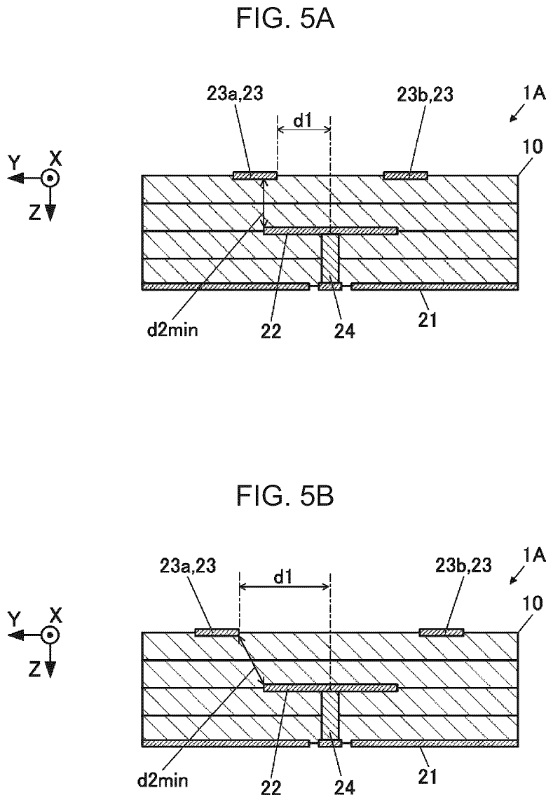

FIGS. 5A and 5B are respectively a first example and a second example of longitudinal sectional views that explain a minimum distance between the energization patch conductor and the non-energization patch conductor.

Here, a length which is a minimum distance d2min between the energization patch conductor 22 and the non-energization patch conductor 23 is introduced. In a configuration (FIG. 5A) in which the energization patch conductor 22 and the non-energization patch conductor 23 are superposed on each other in plan view, the minimum distance d2min between the energization patch conductor 22 and the non-energization patch conductor 23 is a length of a space between the energization patch conductor 22 and the non-energization patch conductor 23 in the upper-lower direction. Accordingly, in this configuration, the minimum distance d2min is not depending on the distance d1. In contrast, in a configuration (FIG. 5B) in which the energization patch conductor 22 and the non-energization patch conductor 23 are not superposed on each other in plan view, the minimum distance d2min increases as the distance d1 increases due to addition of a horizontal component.

The distance d1 of the segments (23a and 23b) of the non-energization patch conductor 23 may be greater than 0 and in a range in which the minimum distance d2min between the energization patch conductor 22 and the non-energization patch conductor 23 is smaller than or equal to (⅛)×λ. When the above-described parameters of the simulation are applied, the condition of d2min≤(⅛)×λ substantially corresponds to d1≤0.514.

The above-described λ corresponds to an effective wavelength corresponding to a center frequency of the target frequency band. That is, a formula λ=c/(f×√Er) holds, where c is the light velocity, f is the center frequency (for example, 64 GHz), and Er is the relative dielectric constant of the dielectric substrate 10. When the range of the distance d1 of the segments is defined by using the effective wavelength λ of the target frequency band, the definition can be applied also to an antenna element of a different target frequency band.

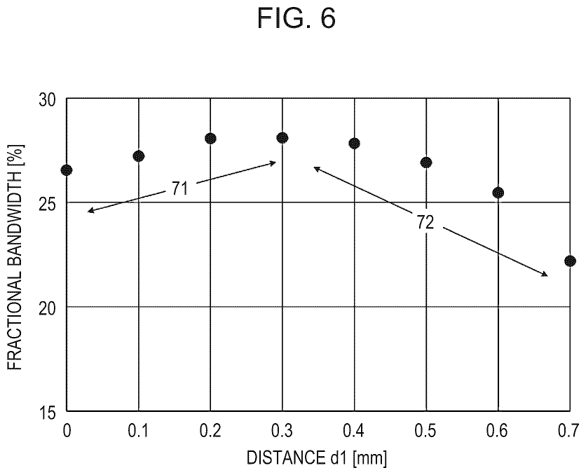

Referring to FIGS. 6 to 11, the characteristics of the antenna element with the distance d1 and the minimum distance d2min defined as above are described.

FIG. 6 is a graph illustrating the relationship between the distance d1 of the segments and a fractional bandwidth. The vertical axis of the graph indicates the ratio (also referred to as a fractional bandwidth) of the width of the frequency band in which reflection is smaller than or equal to −10 dB. The graph is obtained from the results of the simulation. In the simulation, values with which the impedance matching corresponding to the distance d1 is obtained (values of FIG. 4) are applied to the total width wₜₒₜ of the segments (23a and 23b).

In FIG. 6, the fractional bandwidth at d1=0 mm indicates the value of Comparative Example 1 (configured with the non-energization patch conductor 23 as the single unit). With the configuration in which the non-energization patch conductor 23 includes two segments (23a and 23b), the fractional bandwidth increases as the distance d1 increases in a range 71, and the fractional bandwidth reduces as the distance d1 increases in a range 72.

The reason why the fractional bandwidth increases in the range 71 is that, as indicated in the Simith chart illustrated in FIG. 4B, when the distance d1 increases, the closed loop portion of the impedance locus becomes smaller, and thereby the impedance matching is more likely to be obtained in the target frequency band.

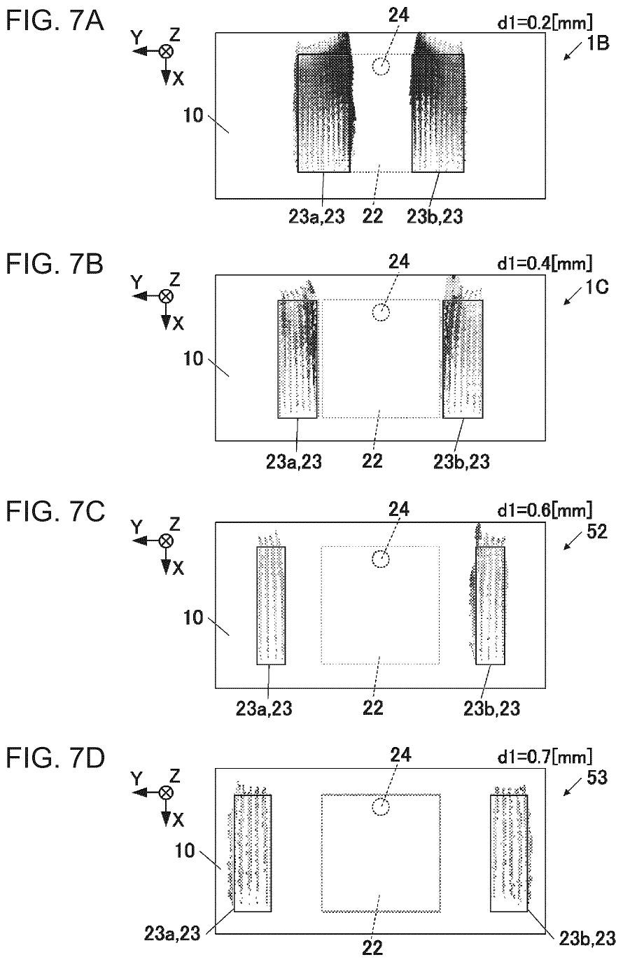

The reason why the fractional bandwidth reduces in the range 72 is described below with reference to FIGS. 7A-7D.

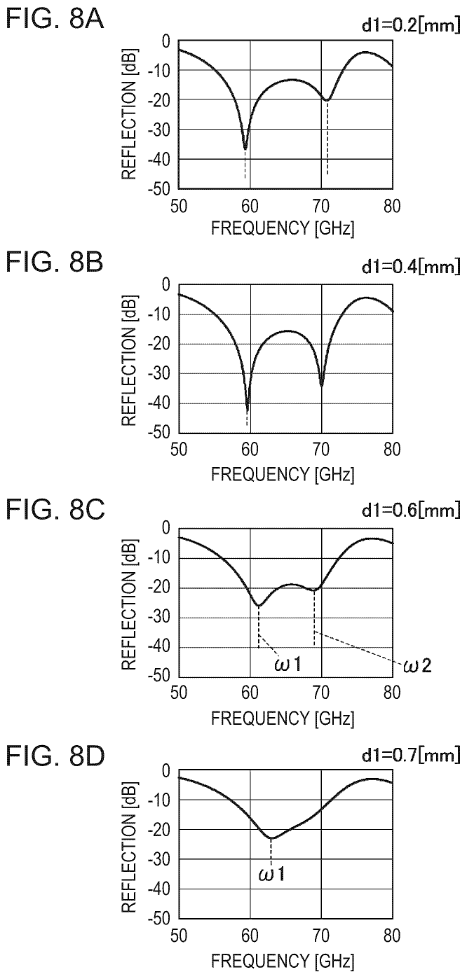

FIGS. 7A to 7D illustrate current density distributions of non-energization patch conductors of Embodiment 2, Embodiment 3, Comparative Example 2, and Comparative Example 3, respectively, that include non-energization patch conductors in which the segments are separated by different distances d1. FIGS. 8A to 8D are graphs respectively illustrating reflection characteristics of Embodiment 2, Embodiment 3, Comparative Example 2, and Comparative Example 3. The current density distributions and the reflection characteristics described above are obtained through the simulation. Dark portions in FIGS. 7A to 7D correspond to portions of high current density.

In an antenna element 1B of Embodiment 2 illustrated in FIG. 7A, d1 is 0.2 mm. In an antenna element 1C of Embodiment 3 illustrated in FIG. 7B, is 0.4 mm.

In an antenna element 52 of Comparative Example 2 illustrated in FIG. 7C, the distance d1 is 0.6 mm. In an antenna element 53 of Comparative Example 3 illustrated in FIG. 7D, the distance d1 is 0.7 mm. In each case, a value with which the impedance matching corresponding to the distance d1 is obtained is applied to the width wₜₒₜ of the segments.

As illustrated in FIGS. 7C and 7D, when the non-energization patch conductor 23 is largely separated from the energization patch conductor 22, electrical interaction between the energization patch conductor 22 and the non-energization patch conductor 23 reduces. Thus, electrical resonance of the non-energization patch conductor 23 reduces in sending the radio wave. As illustrated in FIGS. 8C and 8D, with the configuration in which the non-energization patch conductor 23 is largely separated, the pole ω2 of the resonance frequency becomes shallow or the pole ω2 being one of the poles of the resonance frequency disappears. Accordingly, the frequency band in which the reflection is smaller than or equal to −10 dB is narrowed. For this reason, the fractional bandwidth reduces as the distance d1 increases in the range 72 illustrated in FIG. 6.

The graph of the fractional bandwidth of FIG. 6 indicates that, under the conditions that the distance d1 is greater than 0 and the minimum distance d2min is smaller than or equal to (⅛)×λ (that is, d1≤0.514), a larger fractional bandwidth is obtained compared to that of the configuration of Comparative Example 1 (d1=0). That is, with any of the antenna elements 1A, 1B, and 1C of Embodiments 1 to 3 satisfying the above-described conditions, widening of the band can be achieved compared to Comparative Example 1. The minimum distance d2min is not necessarily smaller than or equal to (⅛)×λ. Even when the minimum distance d2min is in a range greater than that value, compared to Comparative Examples 1 to 3, favorable frequency characteristics such as improvement of the reflection characteristics in the band are obtained.

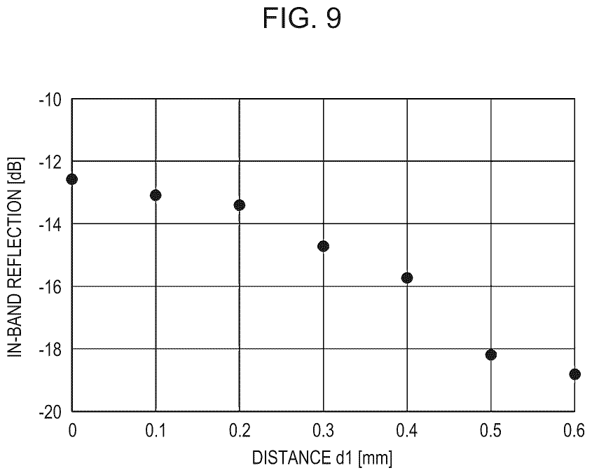

FIG. 9 is a graph illustrating the relationship between the distance d1 of the segments and in-band reflection. The in-band reflection means reflection within a target frequency range. The graph is obtained through the simulation. As indicated in the Simith chart illustrated in FIG. 4B, when the distance d1 increases, the closed loop portion of the impedance locus becomes smaller, and thereby the impedance matching is more likely to be obtained in the target frequency band. Accordingly, the in-band reflection reduces. The graph of the in-band reflection of FIG. 9 indicates that the in-band reflection reduces as the distance d1 increases from 0.

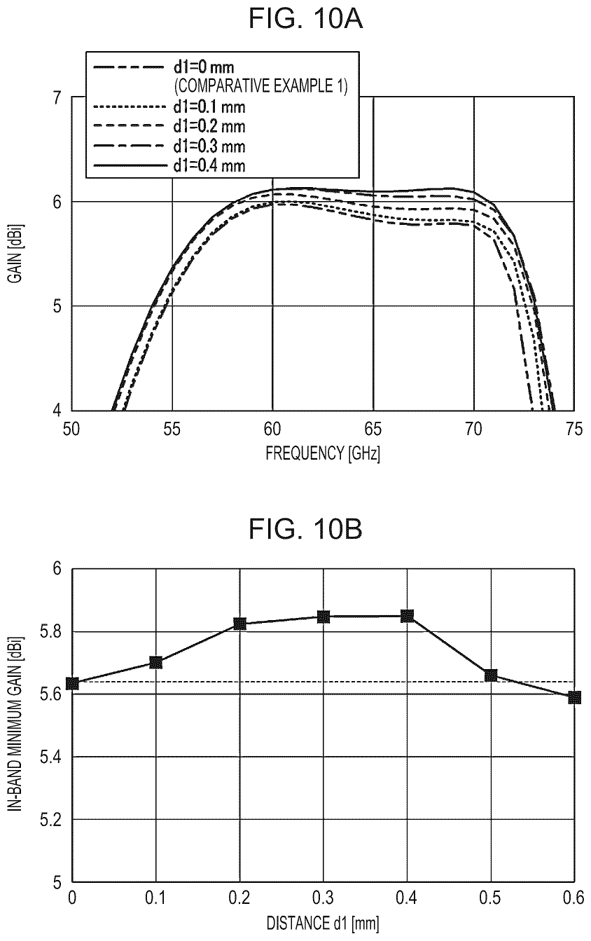

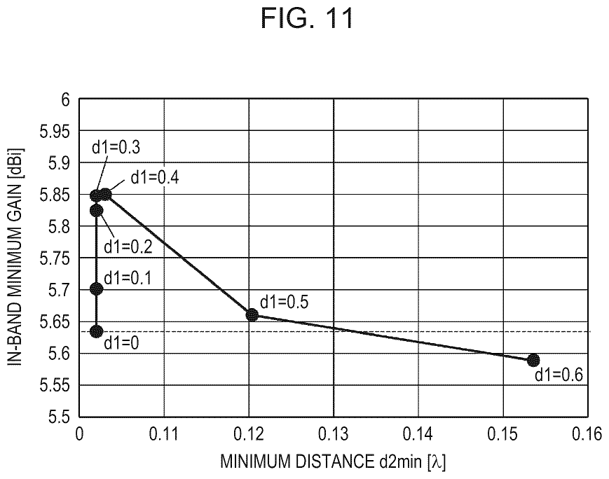

FIGS. 10A and 10B are respectively a frequency characteristic graph and a graph of an in-band minimum gain that illustrate the relationship between the distance d1 of the segments and the gain. FIG. 11 is a graph illustrating the relationship between the minimum distance d2min and the in-band minimum gain. The in-band minimum gain means the minimum value of the gain in the target frequency band. The graphs are obtained through the simulation. As illustrated in FIG. 10A, in a range in which d1 is 0.1 to 0.4 mm, the gain is improved in the entirety of the target frequency band compared to Comparative Example 1 in which d is 0 mm.

The tendency of the magnitude of the gain in the target frequency band is substantially coincident with the tendency of the magnitude of the in-band minimum gain. The graphs of FIG. 10B and 11 indicate that, under the conditions that the distance d1 is greater than 0 and the minimum distance d2min is smaller than or equal to ⅛×λ (=1.25λ), (that is, d1≤0.514), the in-band minimum gain is greater than that of Comparative Example 1 in which d1 is 0. That is, with any of the antenna elements 1A, 1B, and 1C of Embodiments 1 to 3, which satisfy the above-described conditions, the gain in the target frequency band can be improved compared to Comparative Examples 1 to 3. In the graphs of FIGS. 10B and 11, the in-band minimum gain of Comparative Example 1 is indicated by a broken line.

In the configuration in which d1 is set to 0.4 mm, with which the in-band minimum gain is close to the maximum, the energization patch conductor 22 is superposed on neither the first segment 23a nor the second segment 23b of the non-energization patch conductor 23 in plan view. Accordingly, the gain can be further improved with this configuration.

### <Asymmetry of Segments of Non-energization Patch Conductor>

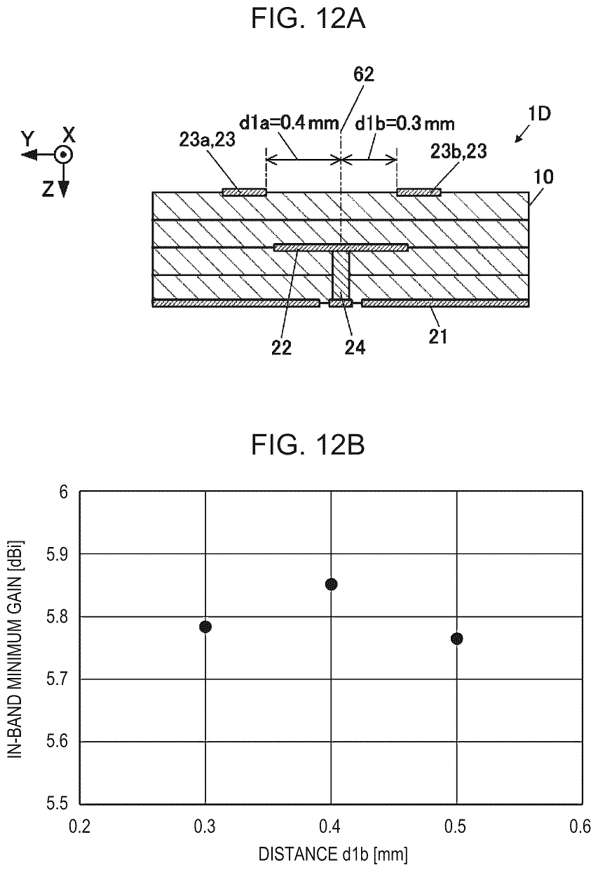

FIG. 12A is a sectional view illustrating an antenna element of Embodiment 4. FIG. 12B is a graph illustrating the relationship between a distance d1b illustrated in FIG. 12A and the in-band minimum gain. This graph is obtained through the simulation.

An antenna element 1D of Embodiment 4 may be the same as the antenna elements 1A, 1B, and 1C of Embodiments 1 to 3 except for that positional symmetry of the first segment 23a and the second segment 23b is different from that of Embodiments 1 to 3.

A distance d1a between the first segment 23a and the central plane 62 is not necessarily the same as the distance d1b between the second segment 23b and the central plane 62. The central plane 62 means a virtual vertical plane extending along the resonance direction and passing through the center of the energization patch conductor 22. The graph of FIG. 12B illustrates the in-band minimum gain when d1a is fixed to 0.4 mm and d1b is changed from 0.3 to 0.5 mm.

This graph indicates that a greater gain than that of the antenna element of Comparative Example 1 can be obtained regardless of whether the positions of the first segment 23a and the second segment 23b (specifically, the positions in a direction perpendicular to the resonance direction in the horizontal direction) are symmetric or asymmetric. The in-band minimum gain of Comparative Example 1 is 5.6 dB. The graph also indicates that the gain is improved more when the above-described positions are symmetric than when the positions are asymmetric.

Although it is not illustrated, the results of the simulation of reflection characteristics indicate that, regardless of whether the positions of the first segment 23a and the second segment 23b are symmetric or asymmetric, the frequency band in which the reflection is smaller than or equal to −10 dB increases compared to that of Comparative Example 1, and accordingly, widening of the band is achieved. It is also indicated that widening is achieved when the above-described positions are symmetric rather than when the positions are asymmetric.

Furthermore, although it is not illustrated, the results of the simulation of radiation patterns indicate that, even when the positions of the first segment 23a and the second segment 23b are asymmetric, the radiation patterns in the Y-Z direction are not significantly changed from those with the symmetric structure.

Accordingly, with the antenna element ID of Embodiment 4, widening of the band can be achieved and the gain can be improved compared to Comparative Example 1.

### <About Length of Non-energization Patch Conductor in Resonance Direction>

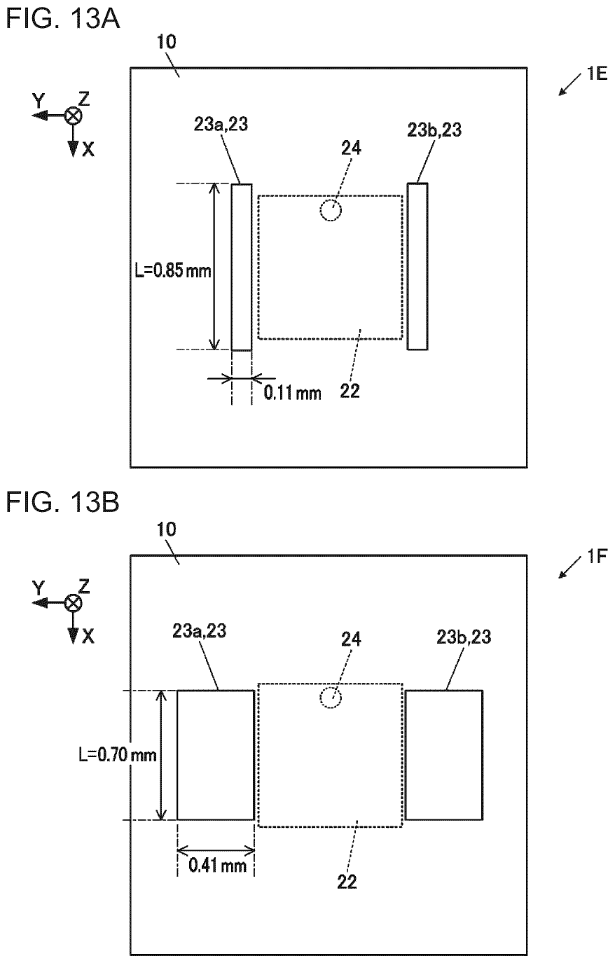

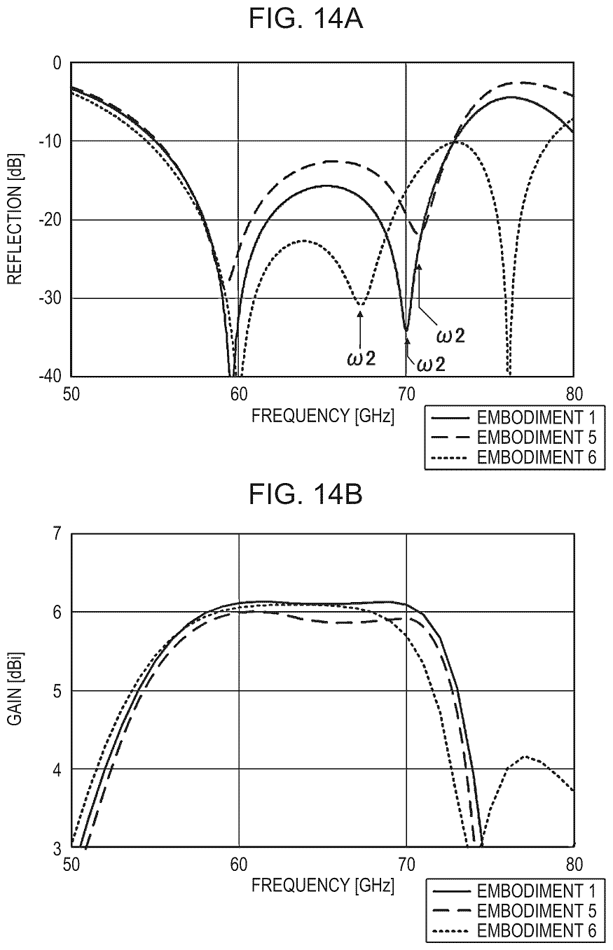

FIGS. 13A and 13B are plan views respectively illustrating an antenna element of Embodiment 5 and an antenna element of Embodiment 6. FIGS. 14A and 14B are a reflection characteristic graph and a gain graph illustrating the frequency characteristics of the antenna elements of Embodiments 1, 5, and 6. The graphs of FIG. 14 are obtained through the simulation.

An antenna elements 1E and 1F of Embodiments 5 and 6 may be the same as and/or similar to the antenna elements 1A to 1C of Embodiments 1 to 3 except for that a length L of the first segment 23a and the second segment 23b in the resonance direction is different from the length of the energization patch conductor 22 in the resonance direction.

Embodiment 5 is an example in which the length of the non-energization patch conductor 23 is greater (L=0.85 mm) than that of the energization patch conductor 22. Embodiment 6 is an example in which the length of the non-energization patch conductor 23 is smaller (L=0.70 mm) than that of the energization patch conductor 22. Corresponding to the difference in the length L in the resonance direction, the width of the individual segments (23a and 23b) are adjusted to 0.11 mm or 0.41 mm so as to obtain the impedance matching. In Embodiment 1, the lengths of the non-energization patch conductor 23 and the energization patch conductor 22 are the same (L=0.75 mm), and the width of each of the segments (23a and 23b) are 0.25 mm. In Embodiment 1, 5, and 6, the distance d1 of the segments is 0.4 mm.

The graph of FIG. 14A indicates that, also with the antenna elements 1E and 1F of Embodiments 5 and 6, widening of the band (specifically, widening of a frequency band in which the reflection is −10 dB) is achieved compared to that with the antenna element of Comparative Example 1. The graph of FIG. 14B indicates that, also with the antenna elements 1E and 1F of Embodiments 5 and 6, the gain is improved compared to the antenna element of Comparative Example 1. It is also indicated that, with the antenna element 1A of Embodiment 1 that includes the non-energization patch conductor 23 and the energization patch conductor 22 having the same length L in the resonance direction, the reflection of the target frequency band is reduced and the gain is improved compared to those with the antenna elements 1E and 1F of Embodiments 5 and 6.

The reason for the differences in the characteristics due to the length L of the non-energization patch conductor 23 is as follows. That is, when the width of the individual segments (23a and 23b) of the non-energization patch conductor 23 are adjusted corresponding to the length L to obtain the impedance matching, an increase in the length L results in reduction of the area of the segments (23a and 23b), and a reduction of the length L results in an increase in the area of the segments (23a and 23b). The change of the area to a larger or smaller area changes the capacitance component of the non-energization patch conductor 23 to a larger or smaller capacitance component and changes the higher pole ω2 of the resonance frequency to a higher or lower value. The differences in the characteristics as described above occur as the value of the pole ω2 changes.

As indicated by FIGS. 14A and 14B, even when the lengths of the non-energization patch conductor 23 and the energization patch conductor 22 are different from each other in the resonance direction, widening of the band can be achieved and the gain can be improved. Specifically, in the resonance direction, the length L of the non-energization patch conductor 23 may be ±15% of the length of the energization patch conductor 22. With this configuration, the widening of the band can be achieved and the gain can be improved. Furthermore, when both the lengths of the non-energization patch conductor 23 and the energization patch conductor 22 are coincident with each other in the resonance direction, further widening of the band can be achieved and the gain can be further improved. The coincidence of the length does not only refer to an exact coincidence but also refers to a case in which the difference in the length is smaller than or equal to an error. The error means, for example, within a tolerance.

### <Configuration in Which Total Number of Segments of Non-energization Patch Conductor is Greater Than or Equal to Three>

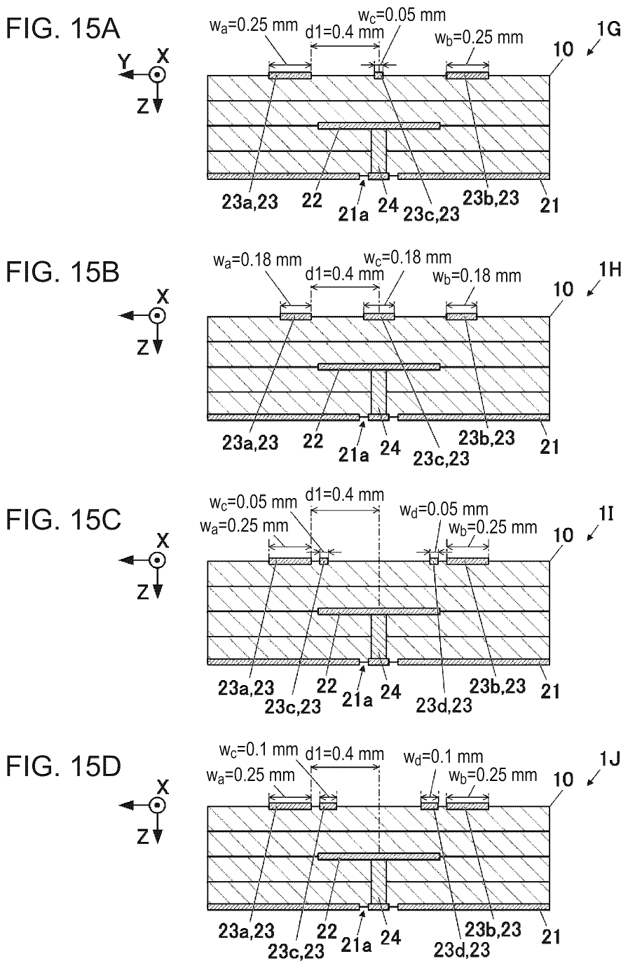

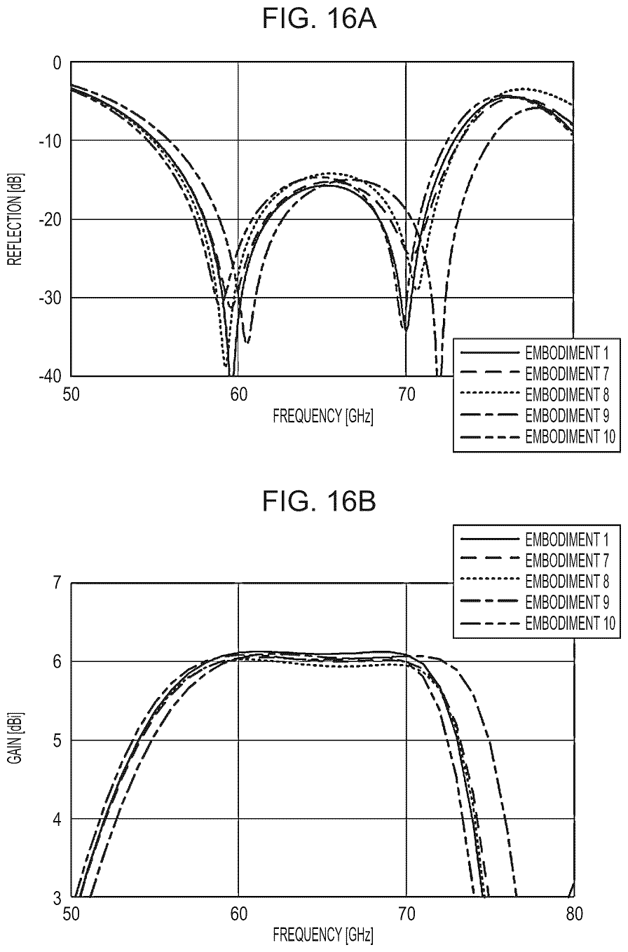

FIGS. 15A to 15D are respectively sectional views illustrating antenna elements of Embodiment 7, Embodiment 8, embodiment 9, and Embodiment 10 in which the total number of the segments of the non-energization patch conductor is greater than or equal to three. FIGS. 16A and 16B are respectively a reflection characteristic graph and a gain graph. These graphs illustrate the frequency characteristics of the antenna elements of Embodiments 1 and 7 to 10.

Antenna elements 1G to 1J of Embodiments 7 to 10 may be the same as and/or similar to the antenna element 1A of Embodiment 1 except for that non-energization patch conductors 23 of the antenna elements 1G to 1J have different configurations. The length of the non-energization patch conductors 23 in the resonance direction may also be the same as and/or similar to that of the antenna element 1A of Embodiment 1. In Embodiments 7 to 10, the widths of the plurality of segments (23a to 23d) of the non-energization patch conductors 23 are respectively denoted by wₐ to w_{d}.

The antenna element 1G of Embodiment 7 is an example in which a third segment 23c having a comparatively small width (w_{c}=0.05 mm) is positioned at the center in a lateral direction. The lateral direction corresponds to a horizontal direction perpendicular to the resonance direction. The antenna element 1H of Embodiment 8 is an example in which the widths of the first to third segments 23a to 23c are adjusted (wₐ=w_{b}=w_{c}=0.18 mm) so that the center of the resonance frequency (that is, between two poles ω1 and ω2) matches the target frequency band. The antenna element 1I of Embodiment 9 is an example in which the third segment 23c and the fourth segment 23d having small widths (w_{c}=w_{d}=0.05 mm) are positioned between the first segment 23a and the second segment 23b. The third segment 23c may be positioned closer to the first segment 23a than to the center in the lateral direction. The fourth segment 23d may be positioned closer to the second segment 23b than to the center in the lateral direction. The antenna element 1J of Embodiment 10 is an example in which the widths of the third segment 23c and the fourth segment 23d are adjusted (w_{c}=w_{d}=0.1 mm) so that the center of the resonance frequency (that is, between two poles ω1 and ω2) matches the target frequency band.

In any of the antenna elements 1G to 1J of Embodiments 7 to 10, a total width wₜₒₜ of the plurality of segments of the non-energization patch conductor 23 is smaller than the width of the energization patch conductor 22. Accordingly, in any of the antenna elements 1G to 1J of Embodiments 7 to 10, the total area of the non-energization patch conductor 23 is smaller than the area of the energization patch conductor 22.

The graphs illustrated in FIGS. 16A and 16B indicate that, also with the antenna elements 1G to 1J of Embodiments 7 to 10, widening of the band is achieved and the gain is improved. It is also indicated that, with the antenna element 1A of Embodiment 1, the reflection of the target frequency band is reduced and the gain is improved compared to those with the antenna elements 1G to 1J of Embodiments 7 and 10.

As indicated by the graphs described above, even when the total number of the segments of the non-energization patch conductor 23 is greater than or equal to three, widening of the band can be achieved and the gain can be improved. Furthermore, with the configuration in which the total number of the segments of the non-energization patch conductor 23 is two, further widening of the band can be achieved and the gain can be further improved.

### Antenna Substrate and Antenna Module

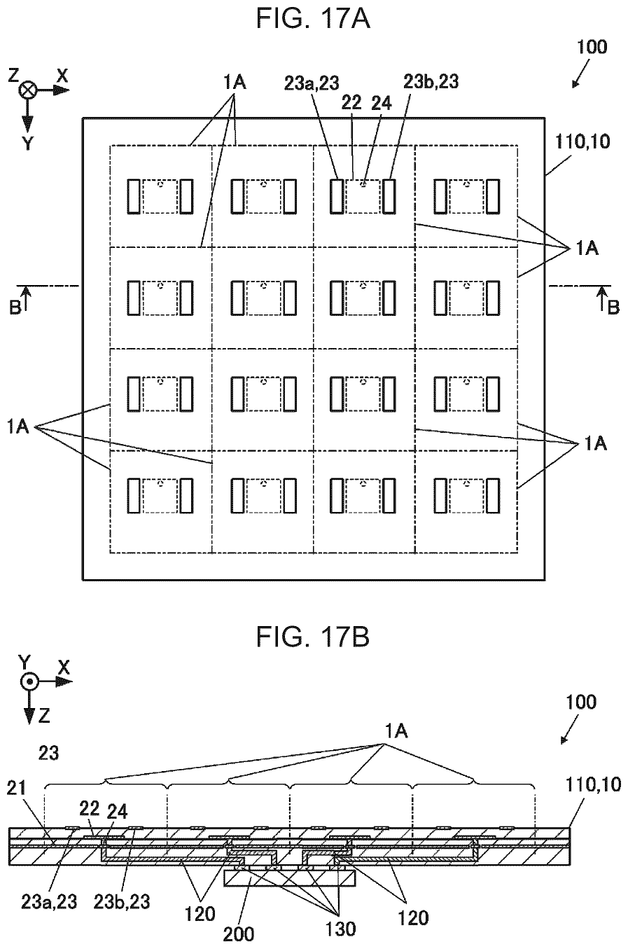

FIG. 17A is a plan view illustrating an antenna substrate and an antenna module of an embodiment according to the present disclosure. FIG. 17B is a longitudinal sectional view taken along line B-B illustrated in FIG. 17A.

In the present embodiment, an antenna substrate 110 includes a plurality of antenna elements 1A. Although each of the antenna elements 1A is the above-described antenna element 1A of Embodiment 1, any of the antenna elements 1B to 1J of Embodiments 2 to 10 may instead be used. The plurality of antenna elements 1A may be arranged in rows and columns in, for example, a matrix shape on the large dielectric substrate 10 or may be arranged in another form.

The antenna substrate 110 may include electrodes 130 and transmission paths 120. An integrated circuit 200 configured to perform at least one of output of a sending signal or input of a receiving signal is connected to the electrodes 130. The signals are transmitted between the electrodes 130 and the antenna elements 1A via the transmission paths 120. The energization conductor 24 of each of the antenna elements 1A may be used as part of a corresponding one of the transmission paths 120.

A filter circuit may be placed on the antenna substrate 110. The filter circuit is configured to extract signals in a desired frequency band from the signals of the transmission paths 120.

In the present embodiment, an antenna module 100 includes the antenna substrate 110 and the integrated circuit 200. The integrated circuit 200 may be joined to a side of the antenna substrate 110 opposite from a side of the antenna substrate 110 from which the radio wave is radiated.

With the antenna substrate 110 and the antenna module 100 of the present embodiment, at least one of sending or receiving of radio waves in a wide band is enabled. Furthermore, since sending of the radio waves in a wide band is enabled, a phase difference is easily added to the sending the radio waves between the plurality of antenna elements 1A. The addition of the phase difference enables beamforming by which the radio waves are formed into a beam shape and output at a desired angle. Accordingly, in the present embodiment, the antenna substrate 110 and the antenna module 100 produces an effect of increasing the likelihood of the beamforming being achieved. Since the gain of the plurality of antenna elements 1A is high, the following effect is also obtained: facilitating application to radio communications at a frequency band with large attenuation in the atmosphere.

The embodiments according to the present disclosure have been described. However, neither the antenna element nor the antenna substrate nor the antenna module is limited to the above-described embodiments. The details described in the embodiments can be appropriately changed without departing from the gist of the invention.

Hereinafter, an embodiment according to the present disclosure is described. In an embodiment,
(1) an antenna element includes
a ground conductor,
   an energization patch conductor positioned on an upper side relative to the ground conductor, and a non-energization patch conductor positioned on an upper side relative to the energization patch conductor.

The energization patch conductor includes a first side and a second side extending along a resonance direction.

The non-energization patch conductor includes a plurality of segments.

The plurality of segments include a first segment positioned along the first side and a second segment positioned along the second side.

In plan view, a total area of the non-energization patch conductor is smaller than an area of the energization patch conductor.
(2) In the antenna element according to (1) described above,
a total number of the segments of the non-energization patch conductor is two.
(3) In the antenna element according to (1) or (2) described above,
in plan view, neither the first segment nor the second segment is superposed on the energization patch conductor.
(4) In the antenna element according to any one of (1) to (3) described above,
a minimum distance between the non-energization patch conductor and the energization patch conductor is smaller than or equal to ⅛×λ, where
λ is an effective wavelength corresponding to a center frequency of a signal frequency band.
(5) In the antenna element according to any one of (1) to (4) described above,
in a longitudinal section perpendicular to the resonance direction, the non-energization patch conductor is symmetric about a line segment that intersects a center of the energization patch conductor and that is perpendicular to an upper surface of the energization patch conductor.
(6) In the antenna element according to any one of (1) to (5) described above,
in the resonance direction, a length of the energization patch conductor is identical to a length of the non-energization patch conductor.

In an embodiment,
(7) an antenna substrate includes
a plurality of antenna elements.

Each of the plurality of antenna elements is the antenna element according to any one of (1) to (6) described above.

In an embodiment,
(8) an antenna module includes
the antenna substrate according to (7) described above and
an integrated circuit.

### Industrial Applicability

The present disclosure can be used for an antenna element, an antenna substrate, and an antenna module.

### REFERENCE SIGNS

1A to 1J antenna element
10 dielectric substrate
21 ground conductor
22 energization patch conductor
22a first side
22b second side
23 non-energization patch conductor
23a first segment
23b second segment
23c third segment
23d fourth segment
24 energization conductor
wₜₒₜ total width
d1, d1a, and d1b distance
d2min minimum distance
ω1 and ω2 pole
62 central plane
100 antenna module
110 antenna substrate
200 integrated circuit

1. An antenna element comprising:
a ground conductor;
an energization patch conductor positioned on an upper side relative to the ground conductor; and
a non-energization patch conductor positioned on an upper side relative to the energization patch conductor;
wherein the energization patch conductor includes
a first side and a second side extending along a resonance direction, wherein the non-energization patch conductor includes
a plurality of segments,
wherein the plurality of segments include
a first segment positioned along the first side, and
a second segment positioned along the second side, and
wherein, in plan view, a total area of the non-energization patch conductor is smaller than an area of the energization patch conductor.

2. The antenna element according to claim 1,
wherein a total number of the segments of the non-energization patch conductor is two.

3. The antenna element according to claim 1,
wherein, in plan view, neither the first segment nor the second segment is superposed on the energization patch conductor.

4. The antenna element according to claim 1,
wherein a minimum distance between the non-energization patch conductor and the energization patch conductor is smaller than or equal to ⅛×λ, where
λ is an effective wavelength corresponding to a center frequency of a signal frequency band.

5. The antenna element according to claim 1,
wherein, in a longitudinal section perpendicular to the resonance direction, the non-energization patch conductor is symmetric about a line segment that intersects a center of the energization patch conductor and that is perpendicular to an upper surface of the energization patch conductor.

6. The antenna element according to claim 1,
wherein, in the resonance direction, a length of the energization patch conductor is identical to a length of the non-energization patch conductor.

7. An antenna substrate comprising:
a plurality of antenna elements,
wherein each of the plurality of antenna elements is the antenna element according to claim 1.

8. An antenna module comprising:
the antenna substrate according to claim 7; and
an integrated circuit.
